(19) United States
(12) Patent Application Publication
(10) Pub. No.: US 2010/0116848 A1
(43) Pub. Date: May 13, 2010

(54) CONDUIT ASSEMBLY FOR A POLYMER HEATED HYDRATION SYSTEM

(76) Inventor: Keith Powers, Frederick, CO (US)

Correspondence Address: Intellipex PLLC, 30200 Telegraph Road, Suite 245, Bingham Farms, MI, 48025, US

(21) Appl. No.: 12/617,931

(22) Filed: Nov. 13, 2009

Related U.S. Application Data
(60) Provisional application No. 61/114,317, filed on Nov. 13, 2008.

(51) Int. Cl. B67D 7/82; A45F 3/20; H05B 3/44

(52) U.S. Cl. 222/146.5; 224/148.2; 222/175; 219/544

(57) ABSTRACT

One embodiment of a conduit assembly for carrying potable liquid may include a tube having a first open end and a second open end. Further, the conduit assembly may include a heating assembly having a sleeve surrounding at least a portion of the tube. The sleeve may be made of a polymer and a plurality of metal particles embedded within the polymer. Furthermore, the conduit assembly may include a power supply and a pair of electrical conductors in connection between the sleeve and the power supply.

### CROSS REFERENCE TO RELATED APPLICATION

This application claims the benefit of U.S. Provisional Application No. 61/114,317 filed on Nov. 13, 2008, the disclosure of which is incorporated by reference.

### FIELD OF THE DISCLOSURE

The present disclosure generally relates to conduits for hydration systems, and, more particularly, to a conduit assembly for a portable hydration system capable of preventing freezing of potable liquid in cold weather conditions.

### BACKGROUND OF THE DISCLOSURE

Water canteens or other carriers may be used to hydrate active individuals while participating in various outdoor activities. For example, water carriers may be used to hydrate skiers, mountaineers, trekkers, and soldiers. However, these carriers may not adequately insulate the water from the ambient temperature, such that the water in the carrier may freeze during use in cold weather conditions.

### SUMMARY OF THE DISCLOSURE

One embodiment of a conduit assembly for carrying a potable liquid may include a tube having a passage communicated between a first open end and a second open end. The conduit assembly may also include a heating assembly having a sleeve surrounding at least a portion of the tube. The sleeve may be made of a polymer and a plurality of metal particles embedded within the polymer. Furthermore, the heating assembly may also have a power supply and a pair of electrical conductors in connection between the sleeve and the power supply to direct current through the sleeve for generating heat from the metal particles and directing the heat toward at least a portion of the sleeve.

One embodiment of a polymer heated hydration system (“system”) may include a carrier constructed and adapted to be worn by an individual. The system may further include a receptacle carried by the carrier and adapted to store a potable liquid. The receptacle may have an inlet opening and an outlet opening. In addition, the system may also have a conduit assembly for carrying the potable liquid. The conduit assembly may include a tube having passage communicated between a first open end and a second open end. Further, the conduit assembly may also include a heating assembly having a sleeve surrounding at least a portion of the tube and the receptacle. The sleeve may be made of a polymer and a plurality of metal particles embedded within the polymer. Furthermore, the heating assembly may also have a power supply and a pair of electrical conductors in connection between the sleeve and the power supply to direct current through the sleeve for generating heat from the metal particles and directing the heat toward the at least one of the sleeve and the receptacle.

### BRIEF DESCRIPTION OF THE DRAWINGS

FIG. 1 is a partially cutaway perspective view of an embodiment of a conduit assembly having a tube, showing the tube having an inner surface defining a passage;

FIG. 2 is a perspective view of a heating assembly of the conduit assembly of FIG. 1;

FIG. 3 is a perspective view of a first cover of the conduit assembly of FIG. 1;

FIG. 4 is a perspective view of a second cover of the conduit assembly of FIG. 1; and

FIG. 5 is a partially exploded view of one embodiment of a polymer heated hydration system utilizing the conduit assembly of FIG. 1.

Like reference numerals refer to like parts throughout the description of several views of the drawings.

### DETAILED DESCRIPTION OF THE DISCLOSURE

The exemplary embodiments described herein provide detail for illustrative purposes and are subject to many variations in structure and design. It should be emphasized, however, that the present disclosure is not limited to a particular conduit assembly for a polymer heated hydration system, as shown and described. It is understood that various omissions and substitutions of equivalents are contemplated as circumstances may suggest or render expedient, but these are intended to cover the application or embodiment without departing from the spirit or scope of the claims of the present disclosure. Also, it is to be understood that the phraseology and terminology used herein are for the purpose of description and should not be regarded as limiting.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

The present disclosure provides a conduit assembly for preventing freezing of a tube dispensing potable liquid from a water hydration system in cold weather conditions.

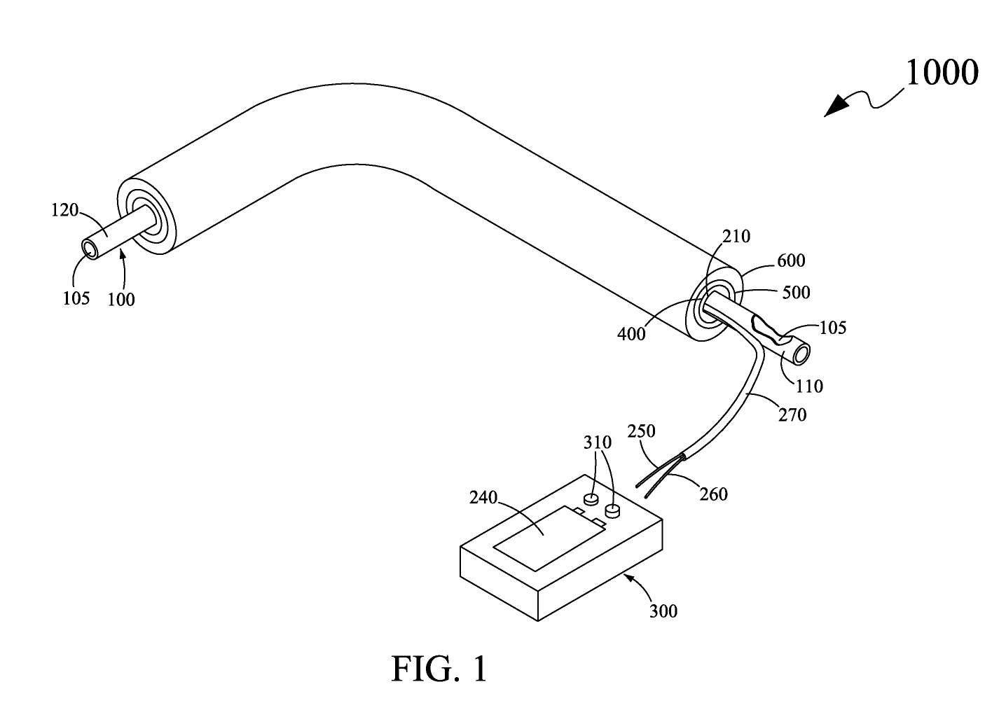

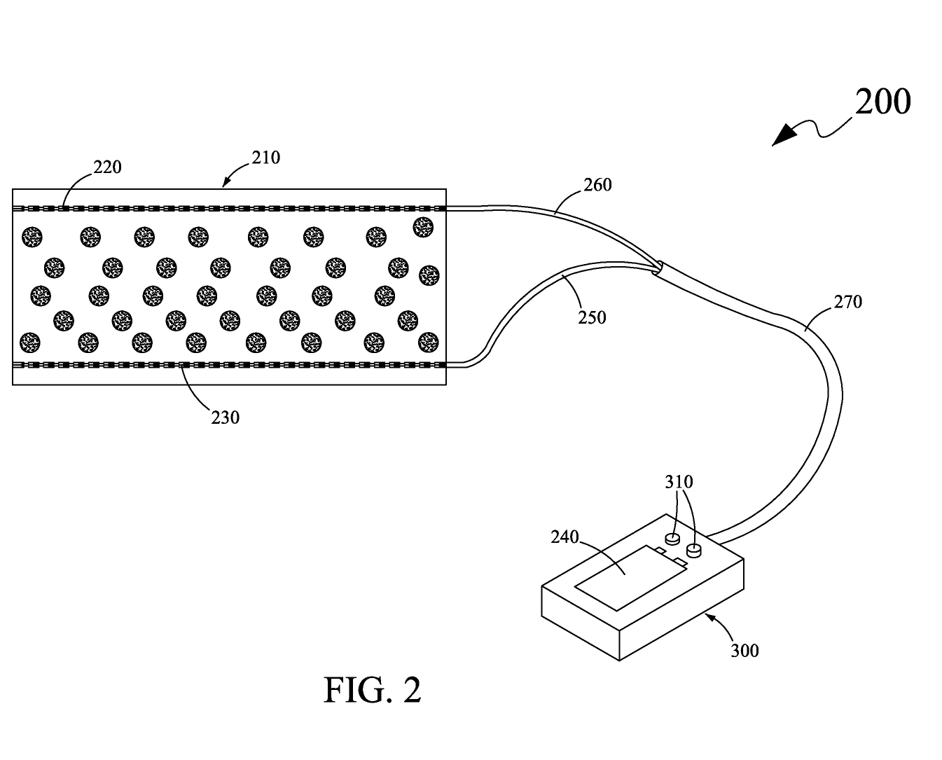

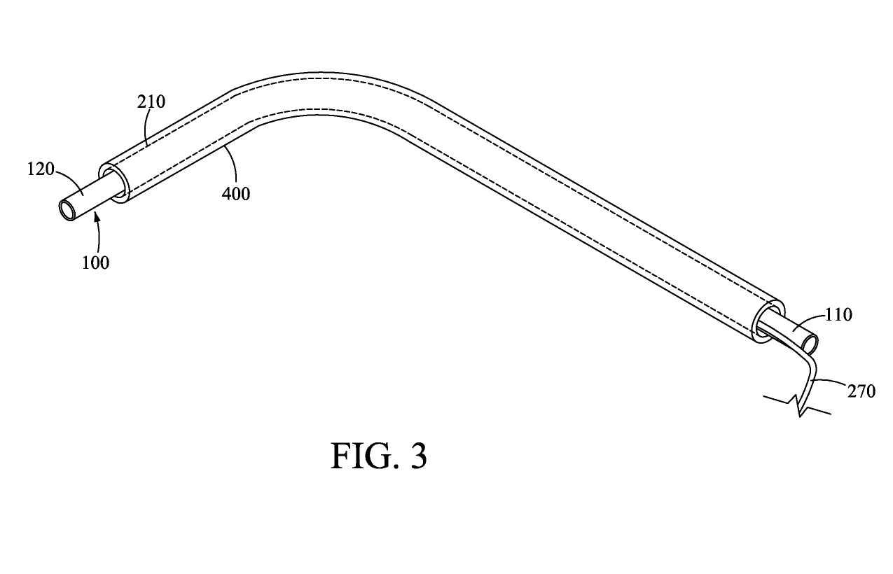

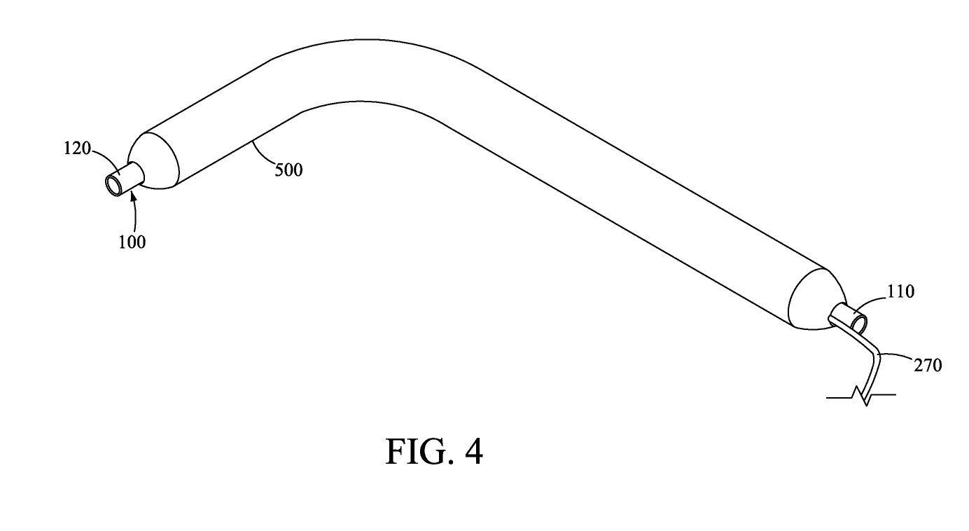

Referring to FIGS. 1-4, one embodiment of a conduit assembly 1000 may be adapted to carry potable liquid (not shown) in cold weather conditions. The conduit assembly 1000 may include a tube 100 having a passage 105 communicated between a first open end 110 and a second open end 120. The tube 100 may be made of a any material capable of withstanding extreme weather conditions. In one form, the tube 100 may be made of a flexible plastic material. In another form, the tube 100 may be made of rubber.

The conduit assembly 1000 may further include a heating assembly 200. The heating assembly 200 may include a sleeve 210 surrounding at least a portion of the tube 100. The sleeve 210 may be made of a polymer material and a plurality of metal particles (not shown) embedded within the polymer material. The metal particles may be spaced apart from each other and have a predetermined coefficient of resistance, such that an electrical current may pass through the sleeve from between the metal particles to generate a predetermined amount of heat. Further, this arrangement may prevent thermal runaway which generates significant heat in one of its portions and may pass the electrical current even if the sleeve is punctured. The sleeve 210 may be made of a waterproof, chemical resistant and a flexible material. In one form, the sleeve 210 may be a made of a material commercially known as FABROC.

Further, the heating assembly 200 may include a pair of electrical conductors 220, 230. The electrical conductors 220, 230 may be made of electrical conducting materials such as tin and copper. The electrical conductors 220, 230 may be disposed on the sleeve 210 in a braided form running parallel along a length of the sleeve 210. The connecting wires 250, 260 may be covered by a covering member 270 or sheathing. Furthermore, the heating assembly 200 may also have a power supply 240 coupled to ends of the connecting wires 250, 260 opposite the sleeve 210, such that the power supply 240 may be adapted to provide power through the wires to the sleeve 210. In one form, the power supply 240 may be a lithium-ion battery. In another form, the power supply 240 may be a nickel-metal hydride battery. In yet another form, the power supply 240 may be a solar rechargeable battery. Further, the sleeve 210 may be adapted to heat up when a current may be allowed to pass through the electrical conductors 220, 230 powered by the power supply 240.

Additionally, the heating assembly 200 may include a controller 300 coupled to the power supply 240 to provide a constant current through the electrical conductors 220, 230 and the sleeve 210. Of course, the controller 300 may instead be configured to provide a predetermined pulse. Further, the heating assembly 200 may also have one or more switches 310 that may selectively connect the power supply 240 to the electrical conductors 220, 230. By regulating the current, the sleeve 210 may be allowed to heat up to a predetermined temperature in order to achieve a uniform distribution of heat, avoid hot spots and conserve battery life.

The conduit assembly 1000 may also include a first cover 400 surrounding the sleeve 210. The first cover 400 may be made of an insulating and soft material, such as a fleece material. The first cover 400 may be adapted to retain the heat produced in the sleeve 210 such that the heat is transferred to the tube 100 and any liquid therein. Of course, the first cover 400 may be made of any suitable insulating material.

Further, the conduit assembly 1000 may include a second cover 500. The second cover 500 may surround the first cover 400 and be made of rubber. In another form, the second cover 500 may be made of a thermoplastic material, such as polyolefin or fluoro-polymer. The second cover 500 in one form may be heat shrunk around the first cover 400 and the tube 100. Heat shrinking of the second cover 500 may be performed with the help of an oven, a hot air gun and the like.

Furthermore, the conduit assembly 1000 may include a third cover 600 that may surround the second cover 500 and may be made of synthetic rubber, such as a neoprene. The third cover 600 may protect and further insulate the sleeve 210 and the tube 100.

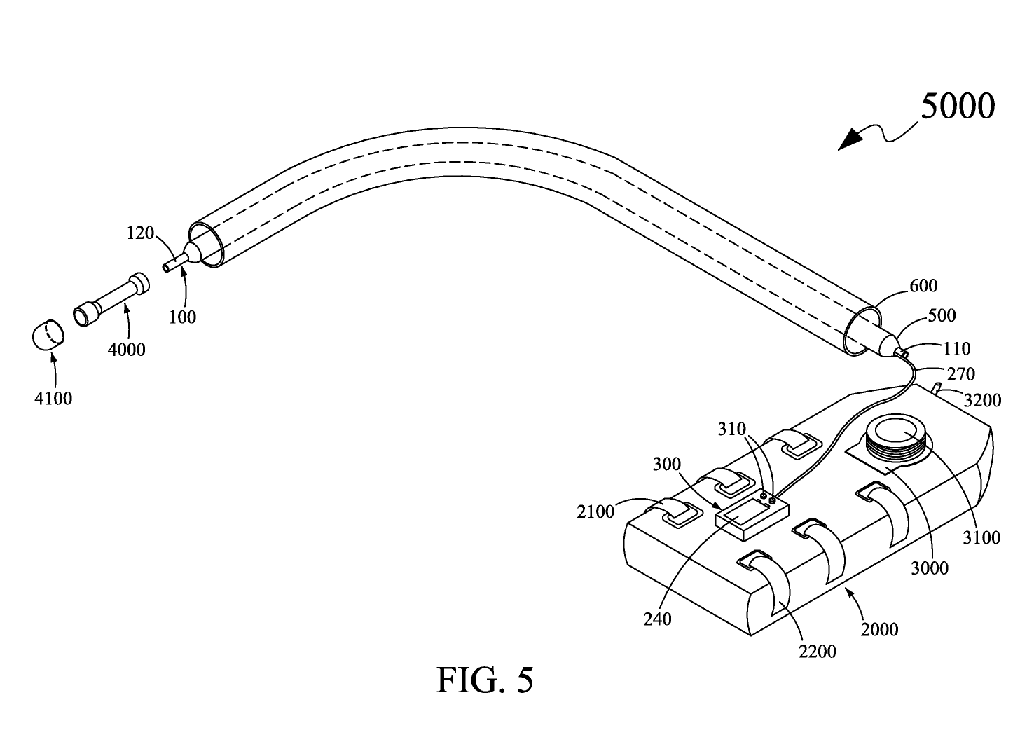

Referring to FIG. 5, an embodiment of a polymer heated hydration system 5000 may include the conduit assembly 1000 of FIGS. 1-4. The system 5000 may be adapted to store and dispense potable liquid (not shown) in cold weather conditions. However, the system 5000 may further include a carrier 2000 that may be constructed and adapted to be worn by an individual. The carrier 2000 may also include at least one one or more fastening members 2100, 2200 capable of securing the carrier 2000 on the individual. Furthermore, the system 5000 may include a receptacle 3000, which may be carried by the carrier 2000 and adapted too store the potable liquid. The receptacle 3000 may have an inlet opening 3100 configured to receive the potable liquid for storage. Further, the receptacle 3000 may also have an outlet opening 3200 communicated with the first open end 110 of the tube 100 of the conduit assembly 1000. The outlet opening 3200 may be configured to dispense the potable liquid stored in the receptacle 3000.

Furthermore, the system 5000 may include a valve 4000 removably attached to the second open end 120 of the tube 100 of the conduit assembly 1000. The valve 4000 may be movable between open and closed positions to selectively communicate with the second open end 120 of the tube 100 for dispensing the potable liquid. Also, the system 5000 may include a cap 4100 releasably carried by the valve 4000.

The system 5000 may further include a sleeve or covering (not shown) that may be similar to the sleeve 210 of FIGS. 1-4. However, the covering may snugly wrap around the tube, the receptacle, the valve, combination thereof and any portion thereof.

In use, the potable liquid may be received through the inlet opening 3100 and into the receptacle 3000. When an individual carrying the system 5000 needs to drink, he or she may use the valve 4000 to draw the potable liquid from the receptacle 3000 through its outlet opening 3200, through the tube 100 and toward the valve 4000. Further, the controller 300 may be actuated to supply power from the power supply 240 to the sleeve 210 for generating heat within the sleeve 210 and transferring the heat to the tube 100 or any portion of the system adjacent to the sleeve 210. Furthermore, the controller 300 may provide one of a constant current and a predetermined pulse to the electrical conductors 220, 230, and the switch 310 may selectively connect the power supply 240 to the electrical conductors 220, 230. The controller 300 in one form may regulate the constant current in order to allow the sleeve 210 to heat up to the predetermined temperature in order to achieve a uniform distribution of heat. Further, the first cover 400 may insulate the sleeve 210 and the tube 100 and prevent the loss of heat. In addition, the second and third covers 500, 600 may secure the sleeve 210 and the first cover 400 to the tube 100 and further insulate the sleeve 210 and the tube 100. Accordingly, the conduit assembly 1000 may reduce or prevent the potable liquid from freezing in any portion of assembly or the hydration system. The conduit assembly 1000 may help to dispense the potable liquid irrespective of the cold weather conditions, thereby helping people to keep themselves hydrated in the cold weather conditions

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, and to thereby enable others skilled in the art to best utilize the present disclosure and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the claims of the present disclosure.

What is claimed is:

1. A conduit assembly for carrying potable liquid, comprising:
a tube having a first open end and a second open end;
a heating assembly including
a sleeve surrounding at least a portion of the tube, and the sleeve being made of a polymer and a plurality of metal particles embedded within the polymer;
a power supply; and
a pair of electrical conductors in connection between the sleeve and the power supply.

2. The conduit assembly of claim 1, further comprising a controller coupled to the power supply to provide one of a constant current and a predetermined pulse to the pair of electrical conductors.

3. The conduit assembly of claim 1, further comprising a switch selectively connecting the power supply to the pair of electrical conductors.

4. The conduit assembly of claim 1, wherein the plurality of metal particles are spaced apart from each other.

5. The conduit assembly of claim 1, wherein a pair of connecting wires is capable of electrically connecting the pair of electrical conductors and the power supply.

6. The conduit assembly of claim 1, further comprising a first cover adapted to cover the sleeve.

7. The conduit assembly of claim 1, further comprising a second cover adapted to be heat shrinked for securing the first cover and the sleeve on the tube.

8. The conduit assembly of claim 1, further comprising a third cover removably carried by the tube.

9. A polymer heated hydration system, comprising:
a carrier constructed and adapted to be worn by an individual;
a receptacle carried by the carrier and capable of storing potable liquid, the receptacle having an inlet opening and an outlet opening;
a conduit assembly for carrying the potable liquid, the conduit assembly comprising
a tube having a first open end and a second open end, the first open end communicated with the outlet opening,
a heating assembly including
a sleeve surrounding at least a portion of the tube and the receptacle, and the sleeve being made of a polymer and a plurality of metal particles embedded within the polymer,
a power supply, and
a pair of electrical conductors in connection between the sleeve and the power supply; and
a valve movable between open and closed positions to selectively communicate with the second open end of the tube and dispense the potable liquid.

10. The polymer heated hydration system of claim 9, wherein the conduit assembly further comprises a controller coupled to the power supply to provide one of a constant current and a predetermined pulse to the pair of electrical conductors.

11. The polymer heated hydration system of claim 9, wherein the conduit assembly further comprises a switch selectively connecting the power supply to the pair of electrical conductors.

12. The polymer heated hydration system of claim 9, wherein the plurality of metal particles are spaced apart from each other.

13. The polymer heated hydration system of claim 9, wherein a pair of connecting wires is capable of electrically connecting the pair of electrical conductors and the power supply.

14. The polymer heated hydration system of claim 9, further comprising a first cover adapted to cover the sleeve.

15. The polymer heated hydration system of claim 9, further comprising a second cover adapted to be heat shrinked for securing the first cover and the sleeve on the tube.

16. The polymer heated hydration system of claim 9, further comprising a third cover removably carried by the tube.

17. The polymer heated hydration system of claim 9, further comprising a cap capable of being releasably carried by the valve.
